(19) United States
(12) Patent Application Publication
(10) Pub. No.: US 2003/0093952 A1
(43) Pub. Date: May 22, 2003

(54) Window shade

(75) Inventor: Ming Nien, Chang Hua Hsien (TW)

Correspondence Address: BROWDY AND NEIMARK, P.L.L.C., ATTORNEYS AT LAW, SUITE 300, 624 NINTH STREET, N.W., WASHINGTON, DC, 20001-5303, US

(73) Assignee: Nien Made Enterprise Co., Ltd., Chang Hua Hsien (TW)

(21) Appl. No.: 10/326,077

(22) Filed: Dec. 23, 2002

Related U.S. Application Data
(63) Continuation of application No. 09/798,966, filed on Mar. 6, 2001.

(30) Foreign Application Priority Data
Feb. 7, 2001 (TW) 09201844

(51) Int. Cl. E06B 7/08

(52) U.S. Cl. 49/92.1

(57) ABSTRACT

A window shade comprises a lower rail, two upright posts, an upper rail, and a plurality of rail members. The upright posts are connected uprightly with two sides of the lower rail. The upper rail is connected with free ends of the upright posts. Each of the rail members has a main body, a through hole, and a rod. The through hole penetrates two side ends of the main body. The rod is disposed in the through hole such that two ends of the rod are jutted out of the through hole to be connected between the two upright posts. The rail members are parallel to one another and are connected between the two upright posts.

### CROSS REFERENCE TO RELATED APPLICATION

The present application is a continuation of Ser. No. 09/798,966, filed Mar. 6, 2001, the entire contents of which are hereby incorporated by reference.

### FIELD OF THE INVENTION

The present invention relates generally to a window shade, and more particularly to an improvement on the window shade.

### BACKGROUND OF THE INVENTION

As shown in FIG. 1, the conventional wooden Venetian blind 1 comprises a lower rail 2; two upright posts 3 fastened uprightly with two ends of the lower rail 2; a plurality of slots 4 which are disposed in opposite sides of the two upright posts 3 and are arranged correspondingly; an upper rail 5 which is fastened at both ends with the free ends of the two upright posts 3; a plurality of rail members 6 which are provided at two ends thereof with a second slot 7; a plurality of connection pins 8 whose one end is received in the first slot 4 and whose other end is received in the second slot 7 for pivoting the rail members 6 in a parallel manner between the two upright posts 3; a moving rod 9 connected with each rail member 6 such that the connection position is not located on the axial line of the pivoting center of each rail member 6, and that each rail member 6 is actuated by the moving rod 9 to swivel for controlling the swiveling angle of each rail member 6, thereby enabling each rail member 6 to remain in the closed state or the open state.

The window shade 1 has two drawbacks. In the first place, the connection pins 8 are received in the slots 4 and 7 of the rail members 6. In light of the slots 4 and 7 being small in depth, the carrying strength of the rail members 6 and the upright posts 3 is insufficient to result in separation of the window shade in the midst of assembly or transportion. The second drawback has to do with the structural strength of the rail members 6, which are intended to stop the solar heat and radiation. After a prolonged use of the rail members 6 under the circumstance in which temperature changes abruptly, the rail members 6 are susceptible to heat stress and deformation in view of the fact that the rail members 6 are of a beam structure and are made of wood, bamboo, or PVC, which has a relatively weak resistance to flexure and deformation. In addition, the connection angles of connection pins 8 and the slots 4 and 7 are apt to change to bring about mechanical friction capable of interfering the rotation of the rail members 6. As a result, the window shade 1 must be repaired or replaced at additional cost.

### SUMMARY OF THE INVENTION

It is the primary objective of the present invention to provide a window shade which is formed of component parts strong in structural strength.

It is another objective of the present invention to provide a window shade which is resistant to flexure and deformation due to temperature fluctuation.

The window shade of the present invention comprises a lower rail, two upright posts vertically connected with two ends of the lower rail, an upper rail connected with the free ends of the two upright posts, and a plurality of rail members, with each having a main body, a through hole, and a rod. The through hole penetrates through the two ends of the main body. The rod is disposed in the through hole such that both ends of the rod are jutted out of the through hole to connect between the two upright posts. The rail members are parallel to one another and are disposed between the two upright posts.

### BRIEF DESCRIPTION OF THE DRAWINGS

FIG. 1 shows a perspective view of a wooden window shade of the prior art.

FIG. 2 shows an exploded view of a preferred embodiment of the present invention.

FIG. 3 shows a partial exploded view of the preferred embodiment of the present invention.

FIG. 4 shows another partial exploded view of the preferred embodiment of the present invention.

FIG. 5 shows a partial enlarged sectional view of the preferred embodiment of the present invention.

FIG. 6 shows still another partial exploded view of the preferred embodiment of the present invention.

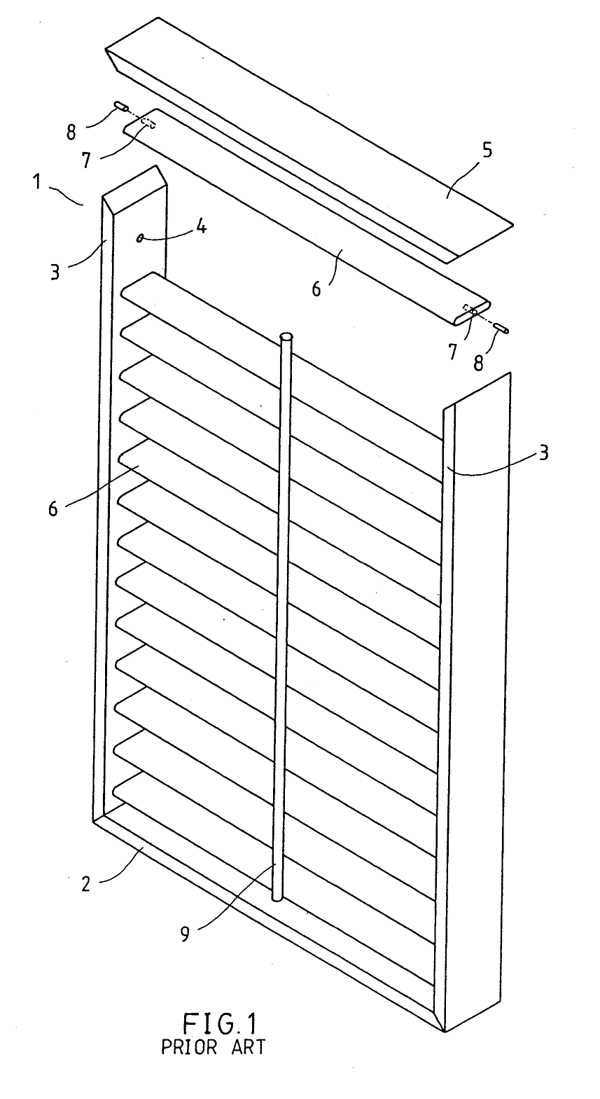

### DETAILED DESCRIPTION OF THE INVENTION

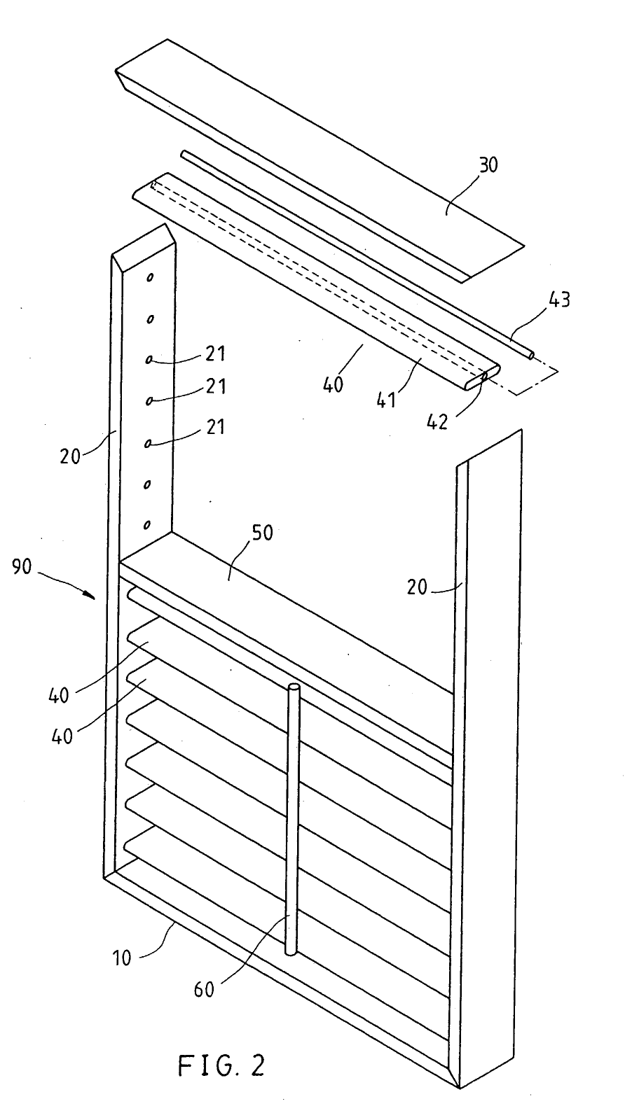

As shown in FIG. 2, a window shade A embodied in the present invention comprises a lower rail 10, two support posts 20, an upper rail 30, a plurality of rail members 90, and a moving rod 60.

The lower rail 10 is of an elongated platelike construction.

The two support posts 20 are uprightly connected with two ends of the lower rail 10 and are provided with a plurality of slots 21.

The upper rail 30 is similar in profile to the lower rail 10 and is connected with the free ends of the two support posts 20.

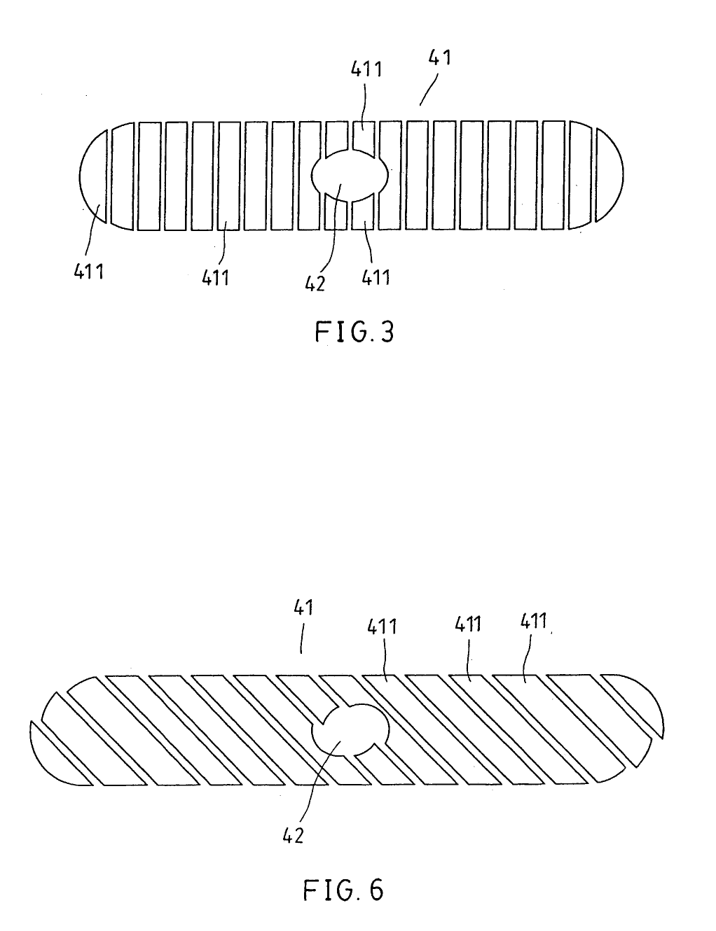

The rail members 90 have a plurality of slats 40 and a dividing rail 50. Each slat 40 has a main body 41, a through hole 42, and a rod 43. As shown in FIG. 3, the main body 41 is formed of a plurality of unit plates 411 which have a predetermined shape and are held together by an adhesive. The through hole 42 is formed by a preformed structure after the joining of the unit plates 411 and is in communication with two end surfaces of the main body 10. The rod 43 is more rigid than the main body 41 and is made of iron. The rod 43 is disposed in the through hole 42 such that two ends of the rod 43 are jutted out of the through hole 42 and are received in the slots 21 of the two support posts 20. The main body 41 is linked to swivel along the axis of the rod 43.

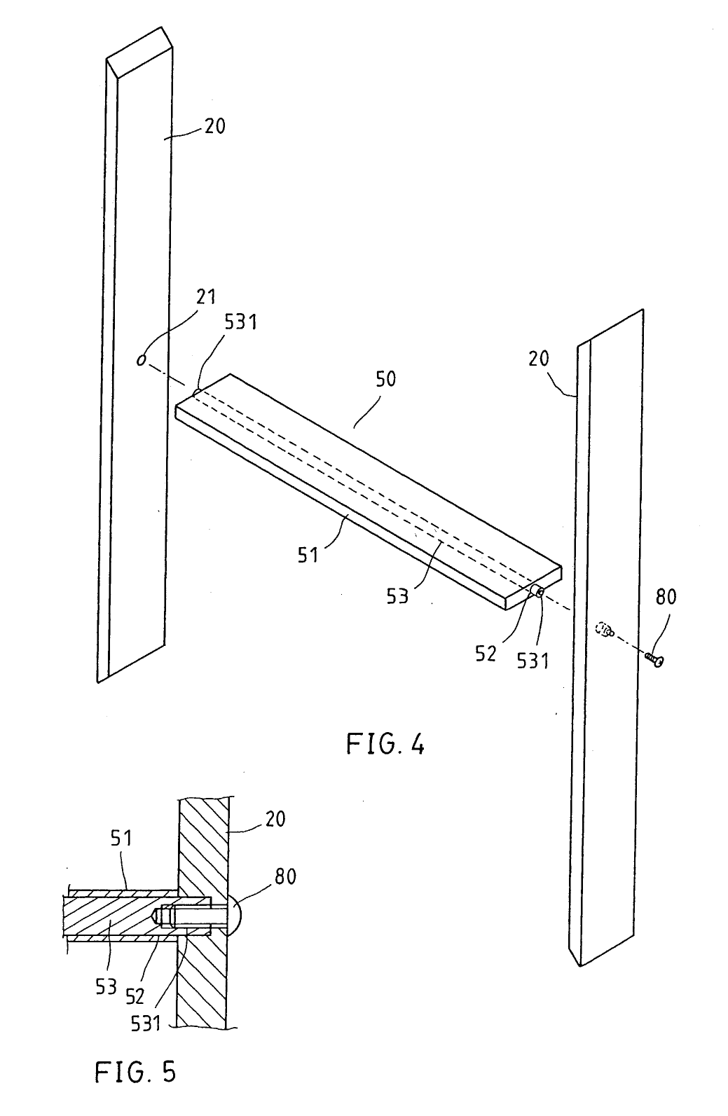

The dividing rail 50 is similar in construction to the slats 40 and has a main body 51, a through hole 52, and a rod 53. The main body 51 is formed of a plurality of unit plates 511 which are pressed together in conjunction with an adhesive. The rod 53 has two inner threaded sections 531, as shown in FIGS. 4 and 5. The rod 53 is fastened in two insertion slots 22 of the two support posts 20 by two screws 80. The dividing rail 50 is intended to divide the space formed by the lower rail 10, two support posts 20, and the upper rail 30, so as to enhance the structural strength and to facilitate the use of the structure in a large window shade.

The moving rod 60 is connected with the slats 40 such that the connection position thereof and the pivoting center of the slats 40 are on the different vertical lines for linking the slats 40 which can be thus swiveled in the same direction at the same time, thereby enabling the slats 40 to be in the closed state or the open state.

The window shade A of the present invention has advantages. In the first place, each slat 40 is connected with the two support posts 20 by the rigid rod 43 which is disposed in the through hole 42. In light of the entire rod 43 being put through each slat 40, the carrying strength of the slat 40 and the rod 43 is excellent. In addition, the rigid rod 43 is put through the weaker main body 41 of the slat 40 so as to make the main body 41 more resistant to flexure and deformation. As a result, the service life span of the slats 40 is prolonged. It must be noted here that each slat 40 of the present invention is formed of a plurality of unit plates 411 by pressing in conjunction with an adhesive, thereby resulting in formation of the through hole 42. As a result, the unit plates 411 have a greater resistance to flexure. In addition, this solves the problem of drilling. The slats 40 of the present invention may be formed into the slats 40 of various patterns and appearances, as well as the through holes 42 of various shapes, as shown in FIG. 6. In the present invention, one or two slats 40 may be selected to enable the fastening mode to be such that the dividing rail 50 and the support post 20 are fastened by screws 80, which form a resistance source along with the friction force of the wall of the support post 20. As a result, there is an appropriate resistance when the moving rod 60 moves each slat 40. This can prevent the slats 40 from being moved inadvertently. The magnitude of the resistance is directly proportional to the fastening depth of the screws 80.

What is claimed is:

1. In a window shade comprising a lower rail; two upright posts connected uprightly with two sides of the lower rail; an upper rail connected with the free ends of the two upright posts; a plurality of rail members, each member having a main body, a through hole, and a rod, said through hole penetrating two side ends of the main body, said rod being disposed in the through hole such that two ends of the rod hut out of the through hole to be connected between the two upright posts, the rail members being parallel to one another and being connected between the two upright posts;
the improvement comprising forming the main body from a plurality of unit plates which have a predetermined shape and are pressed together with an adhesive, and wherein said through hole is formed by a preformed structure after the unit plates have been joined, and wherein the through hole is in communication with two end surfaces of the main body such that the window shade is resistant to flexure and deformation resulting from temperature changes.

2. The window shade as defined in claim 11, wherein said rail members are light-screening slats.

3. The window shade as defined in claim 1, wherein said rail member is a dividing rail.

4. The window shade as defined in claim 1, wherein said rod further has two inner threaded sections, which are formed in two ends of said rod, said two ends being jutted out of said through hole, said rod being fastened between said two support posts by two screws which are engaged with said two threaded sections of said rod.

5. The window shade as defined in claim 1, wherein said rod and said main body of said rail members are made of different materials, said rod being made of a material greater in rigidity than another material of which said main body of said rail members is made.

6. The window shade according to claim 2 wherein the rod further has two inner threaded sections which are formed in two ends of the rod, the two ends jutting out of the through hole, the rod being fastened between two support posts by two screws which are engaged with the two threaded sections of the rod.

7. The window shade according to claim 3 wherein the rod further has two inner threaded sections which are formed in two ends of the rod, the two ends jutting out of the through hole, the rod being fastened between two support posts by two screws which are engaged with the two threaded sections of the rod.
